(19) United States
(12) Patent Application Publication
(10) Pub. No.: US 2014/0198202 A1
(43) Pub. Date: Jul. 17, 2014

(54) INSPECTION METHOD FOR DISPLAY PANEL

(71) Applicant: Samsung Display Co., Ltd., Yongin-City (KR)

(72) Inventor: Jeong-Keun KIM, Yongin-City (KR)

(73) Assignee: Samsung Display Co., Ltd., Yongin-City (KR)

(21) Appl. No.: 14/099,774

(22) Filed: Dec. 6, 2013

(30) Foreign Application Priority Data
Jan. 14, 2013 (KR) 10-2013-0003963

(51) Int. Cl. G02F 1/13; G09G 3/00

(52) U.S. Cl. CPC G02F 1/1309; G09G 3/006
USPC 348/125

(57) ABSTRACT

Disclosed herein is an inspection method for a display panel according to the present embodiments comprising driving the display panel so as to display a first color having a first reference brightness level; photographing the display panel to obtain a first image including at least one particle region; deriving a first particle brightness level of the particle region contrasted to the first reference brightness level from the first image; driving the display panel so as to display a second color having a second reference brightness level higher than the first reference brightness level; photographing the display panel to obtain a second image containing the particle region; deriving a second particle brightness level of the particle region contrasted to the second reference brightness level; and if the second particle brightness level is higher than the first particle brightness level, determining the particle region to be an internal particle.

### CROSS-REFERENCE TO RELATED APPLICATIONS

This application claims priority to and the benefit of Korean Patent Application No. 10-2013-0003963, filed on Jan. 14, 2013, in the Korean Intellectual Property Office, the entire content of which is incorporated herein by reference.

### BACKGROUND

1. Field

The present embodiments relate to an inspection method for display panel, and more particularly, to an inspection method for display panel capable of inspecting defects of image quality using a visual inspection apparatus.

2. Description of the Related Technology

In general, since bad pixels in a display panel such as LCD may occur due to a pattern defect, particles (foreign materials) interposed in the display panel, or the like, the display panel is subjected to a process of inspecting defects of pixels using various inspection apparatuses.

A visual inspection apparatus such as an Auto Visual Tester (AVT), etc. is an apparatus for photographing display panels with a camera, analyzing the photographed images to inspect defects of pixels, and sorting the inspected displays panel according to inspection results.

More specifically, in order to determine defect regions of the display panel, the visual inspection apparatus irradiates external light towards the entire surface of the display panel in a state in which it is not driven, determining regions of the surface from which the light is reflected to be external particles on the outer portion of the display panel (or pseudo defects), and analyzes the photographed image in a state in which the display panel is being driven, determining regions having colors different from a background color to be internal particles interposed in the display panel (or true defects). Here, the regions determined to be the external particles are excluded from defect inspected regions.

However, the inspection method according to the related art has a low accuracy in determining the internal particles. Since the inspection method according to the related art detects not only internal particles but also the external particles in the image, a situation in which distinction between external and internal particles becomes obscure may happen.

For example, the external particle may not be reflected by the external light, but, on the contrary, the internal particle may be reflected by the light. In addition, it is difficult to determine the particles on the rear surface of the display panel.

### SUMMARY

An object of the present embodiments is to provide an inspection method for display panel having improved distinction between external and internal particles at the time of inspecting defects of the display panel using a visual inspection apparatus.

In order to achieve the above mentioned object, according one aspect of the present embodiments there is provided an inspection method for a display panel comprising: driving the display panel so as to display a first color having a first reference brightness level; photographing the display panel to obtain a first image including at least one particle region; deriving a first particle brightness level of the particle region contrasted to the first reference brightness level from the first image; driving the display panel so as to display a second color having a second reference brightness level higher than the first reference brightness level; photographing the display panel to obtain a second image containing the particle region; deriving a second particle brightness level of the particle region contrasted to the second reference brightness level; and if the second particle brightness level is higher than the first particle brightness level, determining the particle region to be an internal particle.

The comparing the first and second particle brightness level to each other to determine the particle region to be an internal particle may be performed under the condition in which the first and second particle brightness levels is above a reference value.

The first and second particle brightness levels may be each either the average brightness level or the maximum brightness level.

The inspection method may further include irradiating external light towards the display panel; and photographing the display panel to determine the region in which the external light is reflected to be an external particle.

The inspection method may further include displaying the display panel so as to display black color; photographing the display panel to determine a region having color different than the black color to be the internal particle; and excluding the region determined to be the external particle among the determined internal particles to set a a remaining region to a first particle candidate group.

The inspection method may further include comparing the first particle brightness level to the second particle brightness level to set a particle region determined to be the internal particle to a second particle candidate group.

The inspection method may further include determining an overlapped region of the first and second particle candidate groups to be the internal particle.

The first and second particle candidate groups may contain position information of the region determined to be the external particle.

The particle region may be the region having color different from background colors in the first and second images.

The first and second colors may be selected in gray scale.

### BRIEF DESCRIPTION OF THE DRAWINGS

The accompanying drawings, together with the specification, illustrate example embodiments, and, together with the description, serve to explain the principles of the present embodiments.

FIG. 1 is a configuration diagram schematically showing a display panel inspection apparatus according to an example embodiment;

FIG. 2 is a detailed configuration diagram showing an inspection part of FIG. 1;

FIG. 3 is a flow chart of an inspection method for display panel according to an example embodiment;

FIG. 4 is an enlarged view of part of a photographed image; and

FIG. 5 is a comparison graph of brightness levels of particle regions according to changing colors.

### DETAILED DESCRIPTION

In the following detailed description, only certain example embodiments have been shown and described, simply by way of illustration. As those skilled in the art would realize, the described embodiments may be modified in various different ways, all without departing from the spirit or scope of the present embodiments. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the other element or be indirectly connected to the another element with one or more intervening elements interposed therebetween. Hereinafter, like reference numerals refer to like elements.

Hereinafter, example embodiments will be described in detail with reference to the accompanying drawings.

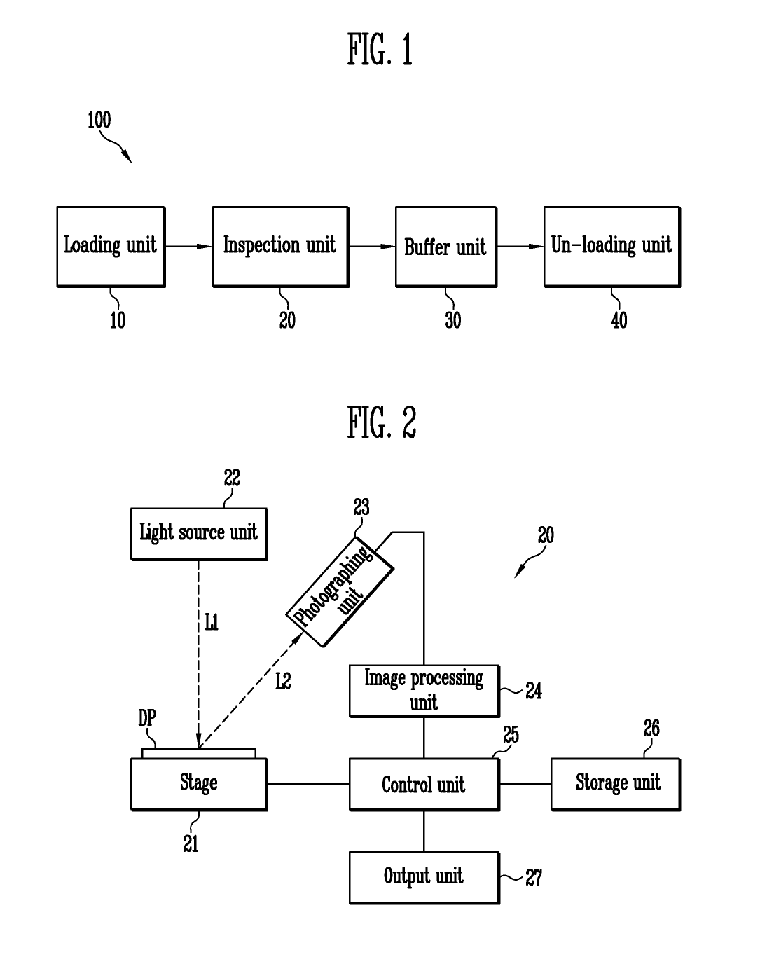

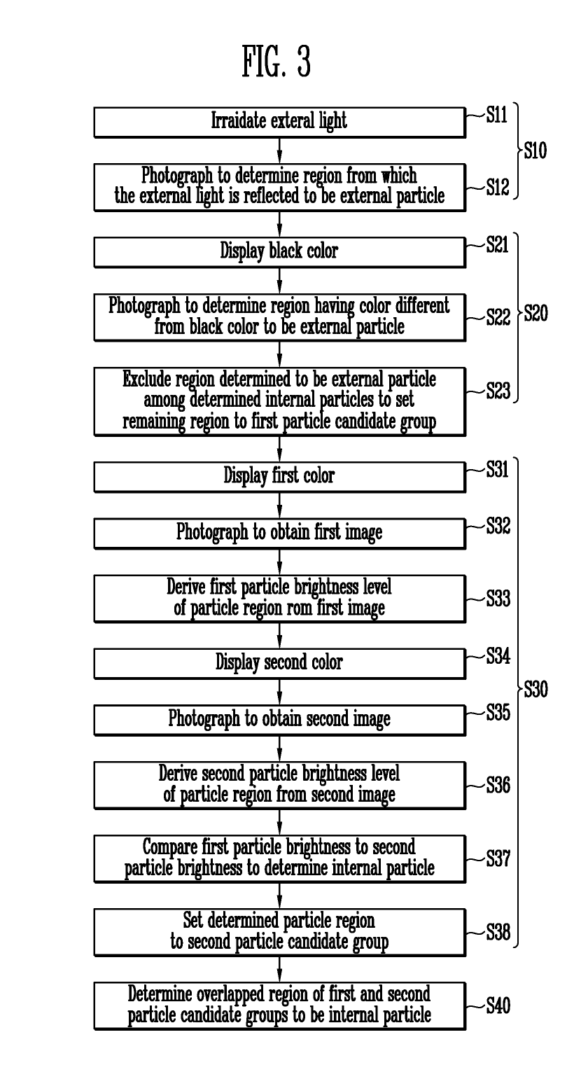

FIG. 1 is a configuration diagram schematically showing an display panel inspection apparatus according to an example embodiment, and FIG. 2 is a detailed configuration diagram showing an inspection part of FIG. 1.

Referring to FIG. 1, the display panel inspection apparatus 100 may be configured to include a loading unit 10, an inspection unit 20, a buffer unit 30, and an unloading unit 40.

The loading unit 10 loads a display panel subjected to be inspected from a cassette (not shown) receiving a plurality of display panels and provides the loaded display panel to the inspection unit 20.

The inspection unit 20 performs a visual inspection process on the provided display panel. A detailed configuration of the inspection unit will be described below with reference to FIG. 2.

The buffer unit 30 is disposed between the inspection unit 20 and the unloading unit 40 to temporarily accommodate the display panel on which the inspection process has been already performed.

The unloading unit 40 sorts the inspected display panels according to inspection results and un-loads the sorted display panels to a subsequent process apparatus or inspection apparatus.

The units configuring the display panel inspection apparatus 100 described above are only examples, and the present embodiments are not limited thereto. In addition, the display panel inspection apparatus 100 may further include a transfer apparatus such as a robot arm, a conveyer belt, or the like, for transferring the display panel from unit to unit, and a controller for controlling the transfer apparatus.

Referring to FIG. 2, the inspection unit 20 may include a stage 21, a light source unit 22, a photographing unit 23, an image processing unit 24, a control unit 25, a storage unit 26 and an output unit 27.

The stage 21 supports the display panel DP and may be configured as a rectangular or circular plate. The stage 21 may be connected to a drive unit of the display panel DP to transmit control signals. In addition, the stage 21 may be driven in the horizontal and vertical directions or may be rotatable.

The light source unit 22 is provided over the stage on which the display panel is seated and irradiates external light L1 towards the display panel DP. For example, as the external light L1, an Ar ion laser or a He-based laser may be used.

The photographing unit 23 has a charge-coupled-device (CCD) camera to photograph optical images of the top surface of the display panel DP. When the external light is irradiated to the top surface of the display panel DP, the photographing unit 23 may capture the light reflected from the surface. When the display panel DP is driven, the photographing unit 23 may capture a screen which pictures are being displayed on the display panel DP and obtain images.

The image processing unit 24 processes image data photographed by the photographing unit 23. A plurality of pixels, which configures image data, is implemented by gray levels. The image processing unit 24 may use brightness difference between each pixel and adjacent pixels to evaluate a brightness characteristic value of the corresponding pixel.

The control unit 25 receives the image data from the image processing unit 24 to determine whether there are particles in the image and, if there are particles in it, detect positions of the particles. The control unit 25 may generally control the stage 21, the light source unit 22, and the photographing unit 23.

For example, the control unit 25 may be implemented by hardware such as an electronic control unit (ECU) or a Micro Control Unit (MCU), software executed on the hardware, or a combination thereof.

The storage unit 26 stores image data of the panel display-photographed image and particle data determined through the images. Data stored in the storage unit 26 is managed by the control unit 25.

The output unit 27 displays the inspection results and current states of the display panel DP to users in real time. In addition, user interfaces such as a keyboard, mouse, and the like, (not shown) may be provided in order to input manipulation commands into the display panel inspection apparatus 100.

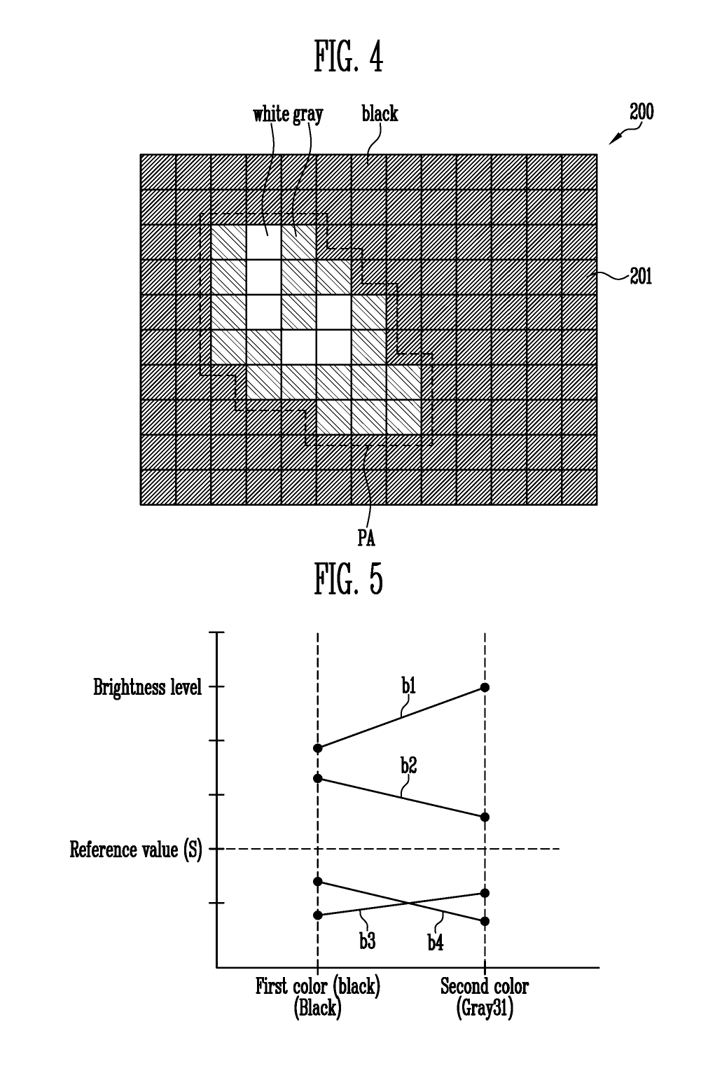

FIG. 3 is a flow chart of an inspection method for display panel according to an example embodiment, FIG. 4 is an enlarged view of part of a photographed image, and FIG. 5 is a comparison graph of brightness levels of particle regions according to changing colors.

Referring to FIG. 3, the inspection method for display panel according to an example embodiment includes a first inspection S1 determining an external particle, a second inspection S20 setting a first particle candidate group, and a third inspection S30 setting a second particle candidate group, and finally also include S40 determining overlapped regions between the first and second particle candidate groups to be internal particles.

External particles are determined through the first inspection S10, and the internal particles are determined through the second and third inspections S20 and S30. Next, at S40, the determined particle regions are compared to each other. The regions determined to be external particles are excluded and overlapped regions of two particle regions are determined to be internal particles.

Here, the sequence of performing the first, second, and third inspections S10, S20, and S30 is only an example. Since the internal particles are determined at the final S40, sequences other than the sequence described above may be performed.

For example, the second and third inspections S20 and S30 may be first performed to determine internal particles, and then the first inspection S10 may be performed to exclude regions which are determined to be external regions.

Hereinafter, the inspection method for display panel performed in the inspecting unit 20 of the display panel inspection apparatus 100 will be described. The display panel DP subjected to be inspected is provided to the inspection unit 20 and then seated on the stage 21 therein. Here, it is assumed that a power supply to drive the display panel DP is connected to a control line.

First, the light source unit 22 irradiates the external light L1 to the display panel DP. Then, the display panel is photographed and the regions from which the external light L1 is reflected are determined to be external particles (S12).

For example, the photographing unit 23 captures the reflected light L2 incident from the display panel DP, and the control unit 25 receives image data from the image processing unit 24 to determine whether there are external particles.

Here, external particles positioned outside the display panel DP are more likely to reflect the external light L1. Therefore, the control unit 25 considers the regions in which the external light is detected as the external particle regions.

Next, the display panel DP is driven so as to display black color (S21). For example, the control unit 25 outputs control signals to the side of the display panel DP connected to the control line.

Then, the display panel is photographed by the photographing unit 23, and the control unit 25 determines the regions having different colors from that of the background of the photographed image to be internal particles (S22).

Referring to FIG. 4, a digital processed image 200 has a plurality of pixels 201, and each pixel 201 has a gray level value. When partially enlarging the region in which a particle is detected, background pixels have black color, and a particle region PA in which the particle is interposed has a grey-white based color.

For example, at the time of driving a liquid crystal display panel, the internal particle affects a liquid crystal tilt, such that the region in which the internal particle is interposed has color different from the background color. In general, when the background color is black, the particle region PA has a bright color.

The particle region having color different from the background color as described above is considered as the internal particle region, and is set to the first particle candidate group, stored and managed.

In some example embodiments, among the region determined to be the internal particle, the region determined to be the external particle through the first inspection S10 is excluded and the remaining region is set to be the first particle candidate group (S23). For example, the control unit 25 stores the first particle candidate group in the storage unit 26.

Next, the display panel DP is driven so as to display a first color having a first reference brightness level (S31). The first color may be selected in gray scale.

In addition, the display panel DP is photographed by the photographing unit 23 to obtain a first image containing at least one particle region (S32).

A first particle brightness level of the particle region contrasted to the first reference brightness level is derived from the first image obtained at S32 (S33). Here, the first particle brightness level may be either an average brightness level or the maximum brightness level.

The particle region in the image may be composed of a plurality of pixels according to the size of the particle, and the first particle brightness level may be set to the average value of respective brightness levels of the pixels.

Next, the display panel DP is driven so as to display a second color having a second reference brightness level higher than the first brightness level (S34). For example, in the case in which the first color is black, the second color may be set to gray whose brightness level is higher than that of black.

In addition, the display panel DP is photographed by the photographing unit 23 to obtain a second image containing at least one particle region (S35).

A second particle brightness level of the particle region contrasted to the second reference brightness level is derived from the second image obtained at S35 (S36).

The first particle brightness level derived at step S33 is compared to the second particle brightness level derived at step S36, and if the first particle brightness level is higher than the second particle brightness level, the particle region is determined to be the internal particle (S37).

Referring to FIG. 5, if the second particle brightness level is higher than the first particle brightness level in the detected particle region as shown in b1 graph, the corresponding particle region is considered to be an internal particle.

If the second particle brightness level is lower than the first particle brightness level in the detected particle region as shown in b1 graph, the corresponding particle region is considered to be an external particle.

In addition, if the first and second particle brightness level is less than a reference value as shown in the b3 or b4 graph, the determination for the corresponding region may not be made or the corresponding region may be considered to be an external particle.

The reason why the internal particle is determined by the comparison of the first particle brightness level and the second particle brightness level is that the external particle is not affected by driving of liquid crystal because of its external location whereas the brightness level of the internal particle may be dramatically changed by driving of the liquid crystal.

In the case of the external particle, the relative brightness level is not changed according to changing colors or the brightness level is lowered due to interception of the light that is transmitted through a liquid crystal layer, whereas in the case of the internal particle the relative brightness level is dramatically changed according to changing colors and the brightness level is raised due to excessive change in twist of liquid crystal.

Although in the example embodiment black color at the low brightness level is displayed to detect the brightness level of the particle region, and then gray color at the high level is displayed to detect the brightness level of the particle region, color at the high level may be first displayed and then color at the low level may be later displayed.

In another example embodiment, in order to improve distinction, two or more colors are displayed such that brightness levels are compared to one another.

If the corresponding region is determined to be the internal particle at S37, it is set to the second particle candidate group (S38). For example, the control unit 25 stores the second particle candidate group in the storage unit 26.

Finally, the overlapped region of the first and second particle candidate groups is determined to be an internal particle (S40). Here, the first and second candidate groups contain position information of the region determined to be an external particle.

The display panel DP inspected according to the number and size of the internal particle determined at S40 may be sorted in the following process.

As described above, in the inspection method for a display panel according to the example embodiment the filtering of the particle inspection is performed through the first, second, and third inspections S10, S20, and S30, thereby making it possible to improve the accuracy of determining internal particles which are the cause of defects of image quality.

As set forth above, the inspection method for display panel according to the present embodiments displays different colors on the display panel and compares brightness levels of the particle regions according to respective colors to determine the internal particle, thereby making it possible to improve accuracy of determining the internal particles which are the cause of defects of image quality.

While the present embodiments have been described in connection with certain example embodiments, it is to be understood that the embodiments are not limited to the disclosed embodiments, but, on the contrary, is intended to cover various modifications and equivalent arrangements included within the spirit and scope of the appended claims, and equivalents thereof.

What is claimed is:

1. An inspection method for a display panel, comprising:
driving the display panel so as to display a first color having a first reference brightness level;
photographing the display panel to obtain a first image including at least one particle region;
deriving a first particle brightness level of the particle region contrasted to the first reference brightness level from the first image;
driving the display panel so as to display a second color having a second reference brightness level higher than the first reference brightness level;
photographing the display panel to obtain a second image containing the particle region;
deriving a second particle brightness level of the particle region contrasted to the second reference brightness level;
comparing the first and second particle brightness levels to each other; and
determining the particle region to be an internal particle when the second particle brightness level is higher than the first particle brightness level.

2. The inspection method for a display panel according to claim 1, wherein comparing the first and second particle brightness level to each other to determine the particle region to be an internal particle is performed under a condition in which the first and second particle brightness levels are above a reference value.

3. The inspection method for a display panel according to claim 1, wherein the first and second particle brightness levels are each either the average brightness level or the maximum brightness level.

4. The inspection method for a display panel according to claim 1, further comprising:
irradiating external light towards the display panel; and
photographing the display panel to determine that the region in which the external light is reflected is an external particle.

5. The inspection method for a display panel according to claim 4, further comprising:
displaying a black color on the display panel;
photographing the display panel to determine a region having a color different than the black color to be the internal particle; and
excluding a region determined to be the external particle among the determined internal particles to set a remaining region to a first particle candidate group.

6. The inspection method for a display panel according to claim 5, further comprising:
comparing the first particle brightness level to the second particle brightness level to set the particle region determined to be the internal particle to a second particle candidate group.

7. The inspection method for a display panel according to claim 6, further comprising:
determining an overlapped region of the first and second particle candidate groups to be the internal particle.

8. The inspection method for a display panel according to claim 1, wherein the first and second particle candidate groups contain position information of the region determined to be the external particle.

9. The inspection method for a display panel according to claim 1, wherein the particle region is the region with a color different from background colors in the first and second images.

10. The inspection method for a display panel according to claim 1, wherein the first and second colors are selected in gray scale.

11. A system for inspection of a display panel, comprising:
a loading unit,
an inspection unit,
a buffer unit, and
an unloading unit,
wherein the inspection unit comprises a stage,
a light source unit,
a control unit configured to drive the display panel so as to display a first color having a first reference brightness level and a second color having a second reference brightness level,
a photographing unit configured to photograph the display panel to obtain at least a first and second image including at least one particle region,
an image processing unit configured to derive a first particle brightness level of the particle region contrasted to the first reference brightness level from the first image, and derive a second particle brightness level of the particle region contrasted to the second reference brightness level;
a storage unit and
an output unit,
wherein the control unit is further configured to determine the particle region to be an internal particle when the second particle brightness level is higher than the first particle brightness level.

12. The system according to claim 11, wherein the first and second particle brightness levels are above a reference value.

13. The system according to claim 11, wherein the first and second particle brightness levels are each either the average brightness level or the maximum brightness level.

14. The system according to claim 11, further comprising:
wherein the light source unit is configured to irradiate external light towards the display panel; and
the photographing unit is configured to photograph the display panel to determine that the region in which the external light is reflected is an external particle.

15. The system according to claim 11, further comprising:
wherein the control unit is configured to display a black color on the display panel;
the photographing unit is configured to photograph the display panel to determine a region having a color different than the black color to be the internal particle; and
the control unit is configured to exclude a region determined to be the external particle among the determined internal particles to set a remaining region to a first particle candidate group.

16. The system according to claim 11, further comprising:
wherein the control unit is further configured to compare the first particle brightness level to the second particle brightness level to set the particle region determined to be the internal particle to a second particle candidate group.

17. The system according to claim 16, further comprising:
wherein the control unit is further configured to determine an overlapped region of the first and second particle candidate groups to be the internal particle.

18. The system according to claim 11, wherein the first and second particle candidate groups contain position information of the region determined to be the external particle.

19. The system according to claim 11, wherein the particle region is the region with a color different from background colors in the first and second images.

20. The system according to claim 11, wherein the first and second colors are selected in gray scale.
